(19) United States
(12) Patent Application Publication
(10) Pub. No.: US 2008/0314847 A1
(43) Pub. Date: Dec. 25, 2008

(54) VENDING SHELF

(76) Inventor: Robert P. Colelli, Yorba Linda, CA (US)

Correspondence Address: PATENT LAW & VENTURE GROUP, 2424 S.E. BRISTOL, SUITE 300, NEWPORT BEACH, CA, 92660, US

(21) Appl. No.: 11/457,792

(22) Filed: Jul. 14, 2006

Related U.S. Application Data
(60) Provisional application No. 60/699,288, filed on Jul. 14, 2005.

(51) Int. Cl. A47F 1/04; B65G 59/00

(52) U.S. Cl. 211/59.3; 221/1

(57) ABSTRACT

A product display system with a shelf, a dispensing member, and a pushing member for dispensing product while making product visible to customers and limiting accessibility of the product so that theft is minimized.

### CROSS-REFERENCE TO RELATED APPLICATIONS

This application claims the benefit under 35 U.S.C. §119 and any other applicable statutes, of U.S. Provisional Application Ser. No. 60/699,288, filed Jul. 14, 2005, the entire content of which is hereby incorporated herein by reference

### FIELD OF INVENTION

The present invention relates generally to a system for displaying merchandise. More particularly, the invention relates to a system for displaying merchandise on a shelf.

### BACKGROUND

The growing presence of large retail stores both in the U.S. and internationally is but one indication of the large populations that such retail stores host on a daily basis. For example, over 100 million people shop in Wal-Mart every week, with Target Stores seeing even higher same-store sales than Wal-Mart in 2006 (www.pbs.org/wgbh/pages/frontline/shows/walmart/secrets/stats.html; http://www.bloomberg.com/apps/news?pid=20601087&sid=aVTcNu9noi9U&refer=top_world news). Such figures indicate the tremendous flow of customer traffic in such stores. What follows, however, is also a tremendous amount of retail theft. For example, shoplifting caused $9.7 billion in losses to U.S. retailers in 2001 (retailindustry.about.com/od/statistics_loss_prevention/1/aa021126a.htm).

One approach to minimizing retail theft is to modify the manner in which product is displayed for customers. Common types of retail displays, such as open shelves, may easily have products swiped from them, and bins make it especially easy to carry off multiple products.

It is also significant for retailers, however, to display product in a manner that it is highly visible to customers and that promotes product appearance. As a result, customers may easily find the items they are searching for and may also be prompted to make purchases of additional products with shelf appeal.

Also, product displays that keep products organized look more appealing to customers and make products easier to find. This is advantageous over several types of displays, such as open shelves common in grocery stores, that have no built-in organization system. This lack of organization leads to products being misplaced and difficult to locate, often wasting customers' time. Another problem with such displays is that having products unorganized diminishes store appearance. On the other hand, having a product display system with built-in organization capability improves the shopping experience by keeping product in place and promoting a store's image of cleanliness and organization. This in turn leads to increased customer satisfaction and favorable sales.

Furthermore, it is helpful for retailers to have product displays that are easily used by employees. In particular, product displays that are easily accessible to employees make product stocking more efficient. Additionally, product displays that keep product organized lessen employees' time needed for organizing products during product stocking or during shopping hours.

It is desirable, therefore, to have product displays that reduce the possibility of product theft. It is also desirable to have product displays that make product visible to customers and promote product appearance. It is further desirable to have product displays with organizational capability. It is also desirable to have product displays that allow for efficient product stocking.

### SUMMARY OF INVENTION

The present invention is a self-contained retractable shelf and pusher system for displaying and dispensing products, while reducing or deterring theft. The invention features generally a product display system for a shelf comprising a shelf, a moveable pusher member, a rotatable dispensing member, a rotatable knob that causes rotation of the dispensing member, a trough portion, and a hinged lid covering at least part of the trough portion, wherein rotation of the dispensing member causes a product to be dispensed in the trough such that the product can be retrieved from the trough by moving the hinged lid to an open position, and wherein access to products on the shelf is minimized when the hinged lid is in the open position.

### DESCRIPTION OF THE ILLUSTRATIONS

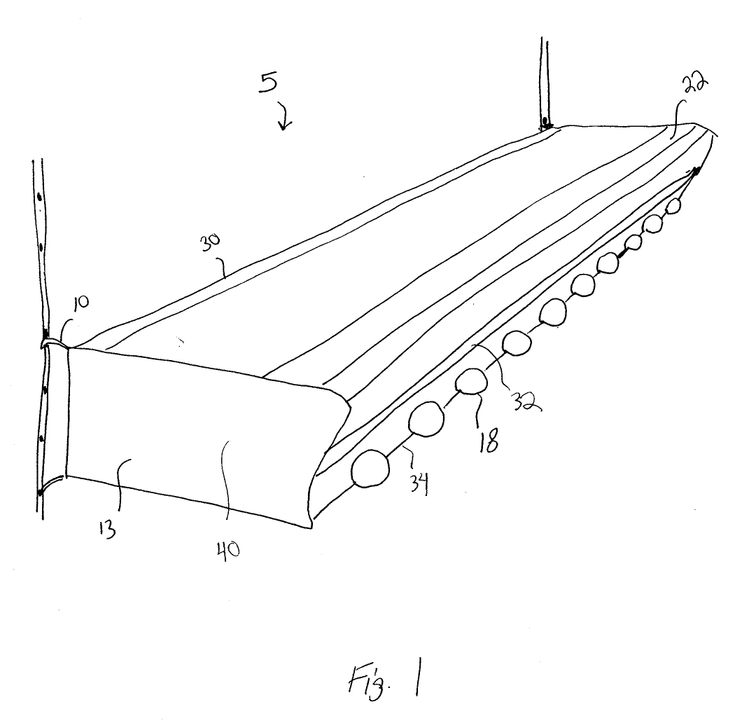

FIG. 1 illustrates a perspective view of a product display shelf;

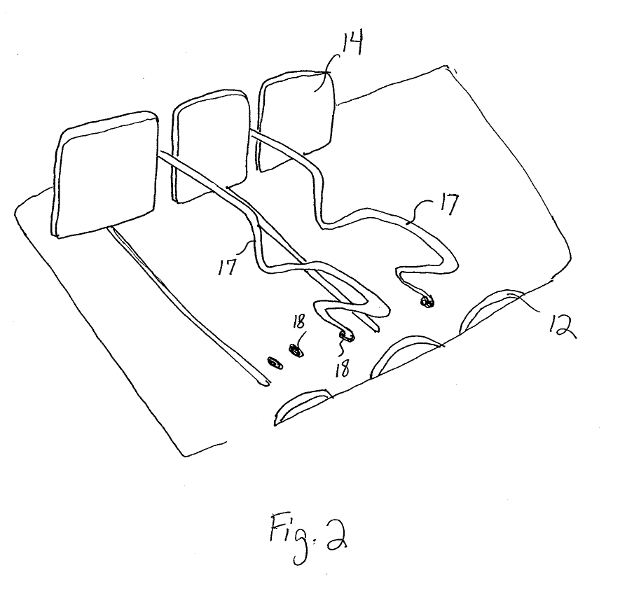

FIG. 2 illustrates a perspective view of a portion of a product display shelf;

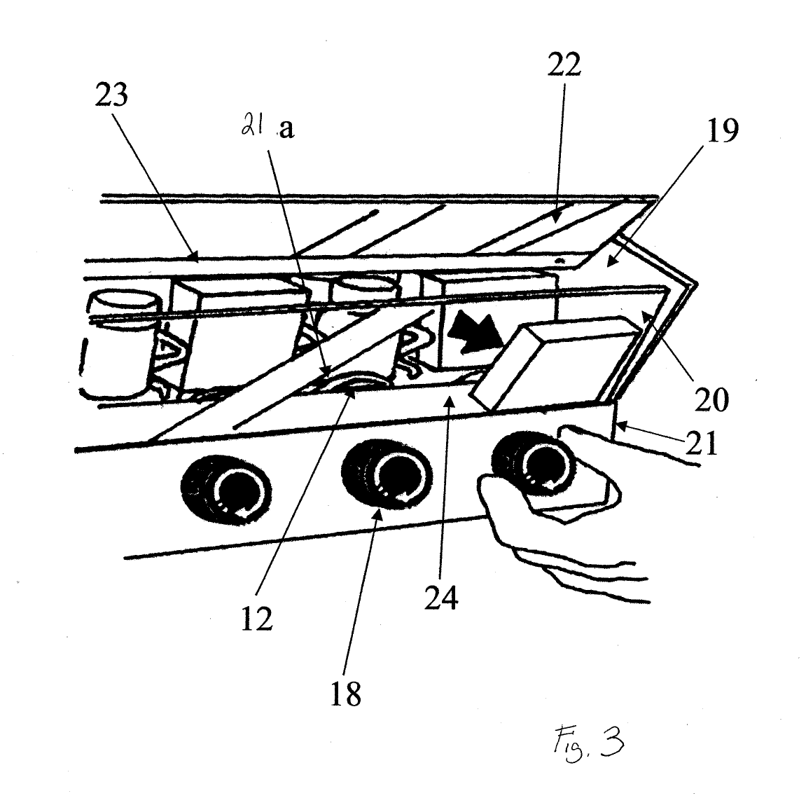

FIG. 3 illustrates a front view of a portion of a product display shelf;

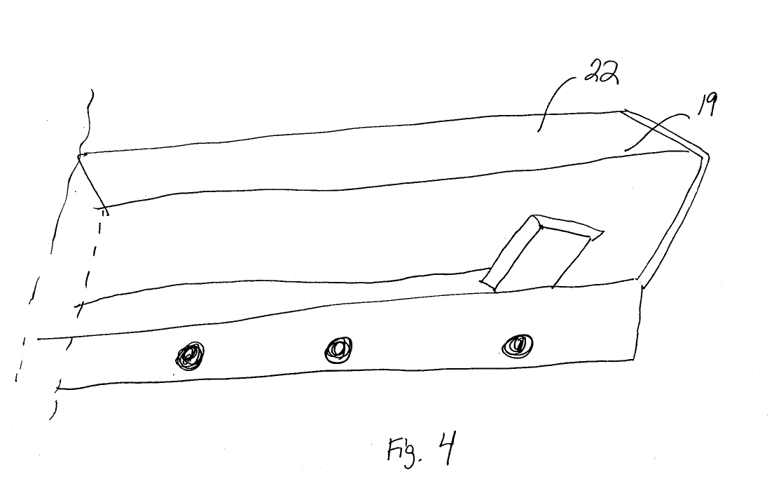

FIG. 4 illustrates an alternative frontal view of a portion of a product display shelf; and

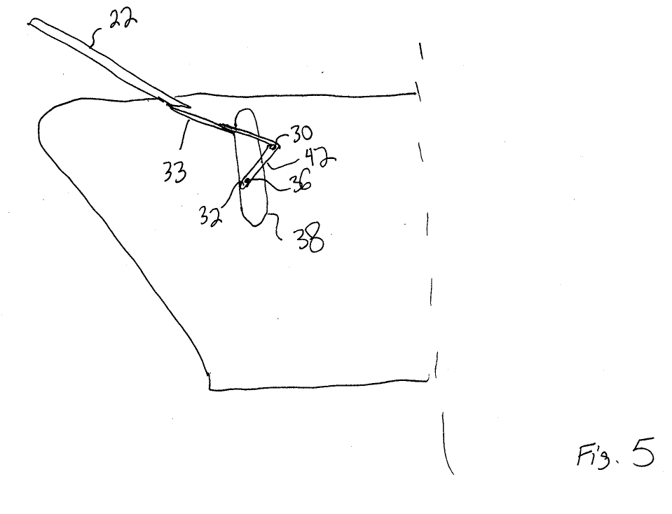

FIG. 5 illustrates a side view of a product display shelf;

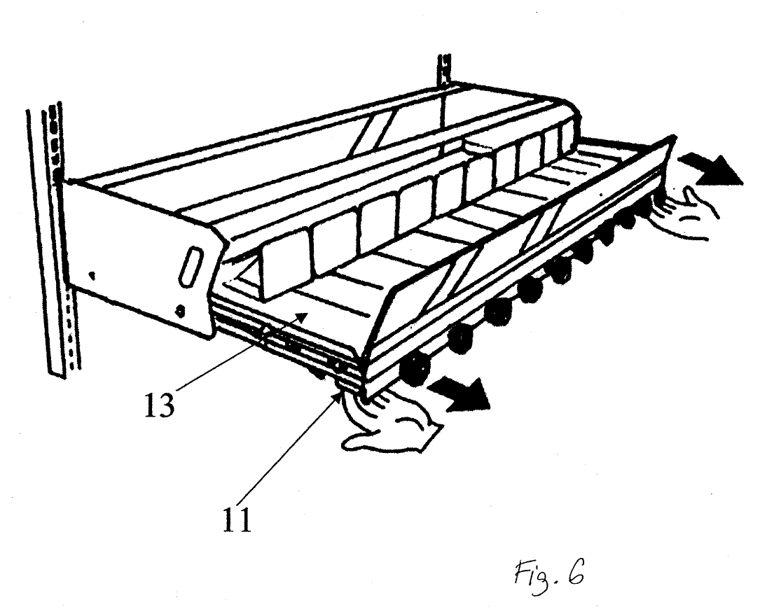

FIG. 6 illustrates a product display shelf being retracted;

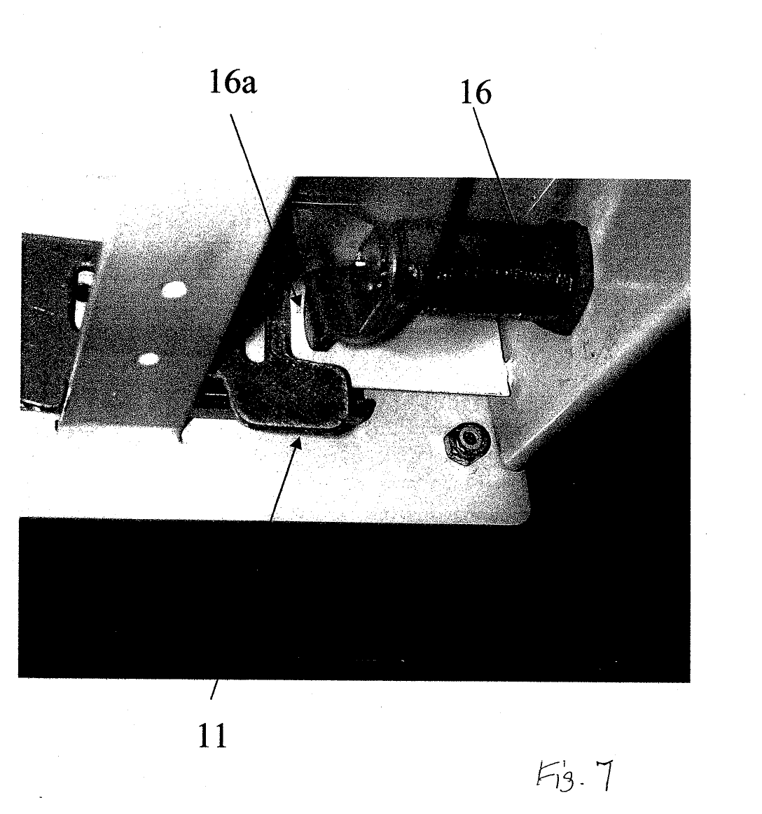

and FIG. 7 illustrates a securing portion of a product display shelf.

### DETAILED DESCRIPTION OF THE INVENTION

The invention comprises a product display system 5 for displaying product merchandise, particularly in a retail setting. FIG. 1 illustrates an embodiment of the product display system 5. The product display system 5 may used on aisles or walls of retail stores, and multiple product display systems 5 may be used in one area. For example, multiple units of the product display system 5 may be vertically stacked in a product display area to a preferred height that allows retail customers to retrieve products. Additionally, a product display area extending the length of an aisle in a retail store may have multiple units of the product display system 5 extending horizontally for the entire length of the aisle.

Returning to FIG. 1 to provide a general description of the invention, the product display system 5 can be employed in a product display area using universal mounting brackets 10 designed to accommodate various-sized slotted gondola uprights 9 common in the marketplace. The product display system 5 comprises a shelf portion 13 on which product is placed for display. The shelf portion 13 comprises a rear portion 30, a front portion 32, and a bottom portion 34. The shelf 13 may also be defined by side panels 40 that provide an additional enclosure for the product. The shelf portion 13 is retractable to allow for the stocking of products. The products may be stocked on the shelf portion 13 in rows formed by dividers 17 inserted in slotted portions 18 to form various row widths, as shown in FIG. 2. A pusher member 14, such as a spring-tensioned pusher 14, is located at or near the rear of the shelf and pushes the product, particularly rows of product, toward the front portion 32 so that the product is easily visible to customers. One or more rotatable knobs 18 located at the front portion 32 coordinate with a corresponding number of dispensing discs 12 to dispense product to a trough area 19, as shown in FIG. 3. A hinged lid 22 covers the trough area when closed. The hinged lid 22 is integrated with a metal support 23 and a product shield 23a to provide a protective barrier to other products on the shelf when the hinged lid is opened 22.

Referring back to FIG. 1 to provide more details of the invention, the product display system 5 is dimensioned to be positionable on standard product storage devices in retail stores, particularly stand-alone aisle and wall units. The shelf portion 13, particularly the rear portion 30, the front portion 32, and the bottom portion 34 are dimensioned to accommodate a wide variety of products, particularly household items. While all sizes of the product display system 5 and the shelf portion 13 may be contemplated, a size for holding and displaying common household consumer products is suitable for the purposes of the invention.

As shown in FIGS. 1 and 2, the bottom portion 34 accommodates a wide variety of products for display to customers. For this purpose, the bottom portion 34 comprises a number of generally aligned and similarly-sized slotted portions 18, as shown in FIG. 2. For example, there may be one row of slotted portions 18 near the front portion 32, or one row of slotted portions 18 near the rear portion 30, or both. The slotted portions 18 are sized to receive dividers 17 insertable in the slotted portions 18. The dividers 17 in turn create rows on the shelf portion 13 which maintains products in one area, thus enhancing both product and store appearance. This organization also makes products easily locatable for customers. Having multiple slotted portions 18 allows for the dividers 17 to be placed in varying widths on the bottom surface 30. This in turn creates rows of varying widths, so that products of various sizes can be stocked. Additionally, since the dividers 17 are easily and quickly removable, store employees may efficiently create and change row sizes while stocking product on the shelf portion 13.

Referring again to FIG. 2, the shelf portion 13 further comprises one or more spring-tensioned pushers 14. The pushers 14 are typically positioned upright on the bottom portion 34. The pushers 14 are tensioned by springs (not shown) mounted at or near the rear portion and located on a side of the pushers 14 opposite where product is placed. The pushers 14 may be pushed against the springs toward the rear portion 30 while product is stocked. In one embodiment, the pushers 14 may be held in place at or near the rear portion 30 with a securing device (not shown) that engages a bottom surface of the pushers 14 with the bottom portion 34 of the shelf 13. When product is stocked in front of the pushers 14, the pushers 14 push the product toward the front portion 32 so that the product is visible to customers. Likewise, as product is removed from in front of each pusher 14, each pusher 14 is moved forward by the spring, which in turn pushes the product toward the front portion 32 so that it remains visible to customers.

As the pushers 14 move the product toward the front portion 32, the product contacts a rotatable dispensing disc 12 located at or near the front portion 32. The illustrations provided herein feature a dispensing disc 12 in a circular form. However, any shape suitable for achieving the intended purpose may be used such as a bar or oval. In one embodiment, the number of pushers 14 corresponds to the number of dispensing discs 12. Each pusher 14 is thus aligned with a dispensing disc 12 so that each pusher 14 consistently pushes product toward a corresponding dispenser disc 12. The dispensing disc 12 serves as both a product stop and a product lifter. The dispensing disc 12 is generally a height such that the product is almost fully viewable behind the dispensing disc 12 while also being able to hold the product in position when the dispensing disc 12 is stationary. When rotated, the dispensing disc 12 causes the product to be dispensed to a location accessible to customers. To provide additional detail, each dispensing disc 12 features a raised portion 12a that engages a bottom portion of the product contacting the disc 12 when the disc 12 is rotated. As the raised portion 12a engages the bottom portion of the product, the product is raised to a height above the disc 12, and the pusher 14 is allowed to move forward a distance equal to the void left by the product lifted. This motion ejects the product into a trough area 19 above the front portion 32 of the shelf 13.

The rotation of each dispensing disc 12 is facilitated by a corresponding knob 18 in communication with the disc 12 and located on the front portion 32. Preferably, each disc 12 has one corresponding knob 18. Likewise, each knob 18 corresponds to the product behind each disc 12, so that a customer rotates the knob 18 corresponding to a desired product in order to get the product. Preferably, from the customer's perspective, each knob 18 is in approximately a same vertical plane as the corresponding product. Each knob 18 is located on the front portion 32 to allow for easy access and maneuverability by customers. The knobs 18 are affixed to the front portion 32 in a semi-permanent fashion and are joined to the dispensing discs 12 by means of a rod or a bolt protruding through a surface of the front portion 32. In this manner, when a knob 18 corresponding to a desired product is rotated by a customer, the dispensing disc 12 is in turn rotated and causes the product to be dispensed, as described above.

In addition to dispensing product, the knobs 18 have an additional sound notification feature. Specifically, each knob 18 features an audible “clicking” sound as it is rotated, preferably in a clockwise manner. This clicking results from two surfaces contacting each other as the knob 18 rotates, such as fins or tabs on the front portion 32 contacting corresponding gears or teeth on the knob 18. In one embodiment, the gears or teeth are on an inner surface of the knob 18. The fins or tabs may be injection-molded on the shelf 13. The clicking sound notification feature serves to notify customers that the rotation of the knob is performing a task that will dispense the product desired, to notify store personnel that products are being dispensed, and to notify a would-be thief that his/her actions may draw unwanted attention.

As shown in FIG. 3, products are dispensed from behind the dispensing discs 12 to the trough area 19. The trough area 19 is located above the knobs 18 on the front portion 32 and is sized to receive a wide variety of products without occupying an excessive amount of space that limits shelf storage space. The trough 19 is defined by a clear plastic front 20, for viewing the product, which is secured to the front portion 32 by way of a “U” channel 21 and an angled portion 21a between the dispensing disc 12 and the clear plastic front 20. The angled portion 19a allows for efficient extraction of the dispensed product.

The trough area 19 is mostly or fully covered by a hinged lid 22, when the hinged lid 22 is in a closed position, as shown in FIG. 4. The hinged lid 22 prevents potential thieves from swiping product off shelves by serving as a barrier. To retrieve the product in the trough area 19, the hinged lid 22 must be lifted to an open position to allow access to the trough area 19. The customer may easily retrieve the product after the hinged lid 22 is lifted to the open position. In the open position, the hinged lid 22 moves up from the trough area 19 a sufficient distance to allow a customer to retrieve the product, but not so far as to allow a potential thief to take the product remaining behind the dispensing discs 12. Thus, the hinged lid 22 also minimizes theft by slowing the process of removing products from the shelf 13, since the hinged lid 22 must be lifted to retrieve product from the trough area 19 and other product on the shelf 13 is not easily accessible.

The hinged lid 22 is comprised of a clear, rigid material, preferably plastic and supported by a metal support 23. The metal support 23 is integrated with a product shield 23a. The product shield 23a provides a protective barrier to the remaining products in the shelf 13 as the hinged lid 22 is lifted to the open position, therefore making it difficult to grab any other product that has not been dispensed into the trough area 19 of the shelf. The hinged lid 22 moves to the open position by operation of a piano hinge 30 and a tracking hinge 32, as shown in FIG. The lid 22 is connected to the piano hinge 30 by a panel 33 extending therebetween. The panel 33 extends approximately the length of the lid 22. When the lid 22 is in the closed position, the closed position of the piano hinge 30 is at an angle of approximately 0-15 degrees, 5-15 degrees, or 5-12 degrees. As the hinged lid 22 is lifted open, the piano hinge 30 rotates open, causing the panel 33 to be lifted with the lid 22. The panel 33 provides an additional barrier to the product on the shelf, because it effectively serves as an extension of the lid 22. The opening of the piano hinge 30 is accelerated compared to the opening of the lid 22, as the lid opens to an angle of approximately 45-75 degrees relative to its closed position, while the piano hinge 30 rotates to an angle of approximately 120-160 degrees relative to its closed position. This is caused by a tracking pin 36, which is operably connected to the tracking hinge 32, that is connected to the piano hinge 30 by a connecting member 42, such as a rod. The tracking pin 36 moves vertically within a tracking slot 38 located on the side panels 40 of the shelf 13. As the lid 22 is opened, the tracking pin 36 moves down the tracking slot 38, allowing the piano hinge 30 to open to an angle that allows the panel 33 to shield the product on the shelf 13.

After the product has been retrieved, the hinged lid 22 automatically returns to the closed position by means of gravity. Should the consumer decide not to purchase the dispensed product, the product may be placed back into the trough area 19 by lifting the hinged lid 22.

As shown in FIG. 6, the shelf portion 13 of the invention may be retracted to a stocking position to allow for the stocking of products. In the stocking position, the bottom portion 34, particularly the dividers 17 and the pushers 14, is open and accessible to the stocker, or store employee. The shelf 13 is retracted to the stocking position by rotating gravity release hardware 11 located on an underside of the shelf portion 13. This operation is typically performed with the fingers. After stocking, the shelf may be returned to a closed, or sales, position by pushing on the front portion 32 of the shelf until the release hardware 11 secures the shelf 13. When the shelf 13 is secured, the shelf 13 may not be pulled open without rotating the release hardware 11. The shelf 13 may further be secured in the sales position by means of a security lock 16, as shown in FIG. 7. The security lock 16 features a cam 16a that engages the gravity release hardware 11 when locked, thereby preventing the rotation of the release hardware and disallowing the shelf to be opened. Both the gravity release hardware 11 and the security lock 16 minimize theft by making it difficult for a potential thief to move the shelf 13 to a position in which the product on the shelf 13 is easily accessible.

To continue with describing a method in which product is retrieved from the product display system 5, a customer will be able to view a desired product on the shelf 13 through the clear plastic front 20 of the trough area 19. The customer then rotates the knob 18 corresponding to the product, wherein the knob 18 is in front of the dispensing disc 12 that helps to hold the desired product in place. For assistance, the knob 18 may have an arrow (not shown) pointing in the knob's 18 rotational direction and the term “open” in an applicable language so a customer is made aware of how to operate the knob 18. When the customer rotates the knob 18, the dispensing disc 12 is in turn rotated, and the raised portion 12a engages a bottom surface of the desired product. As the disc 12 rotates, the product's engagement with the raised portion 12a causes the product to be raised to a height above the disc 12. Then, the pusher 14 moves forward, also pushing the product remaining in the product row forward, to eject the desired product into the trough area 19. The customer then lifts the hinged lid 22 and reaches into the trough area 19 to retrieve the dispensed product. Afterward, the hinged lid 22 returns to the closed position by means of gravity.

To continue with describing a method in which a retail employee may stock the shelf with merchandise, an employee first rotates the gravity release hardware 11 under the shelf portion 13. The employee then retracts the shelf 13 to the stocking position, i.e. so that the bottom surface 3 and dividers 17 are accessible. The employee then moves the dividers 17 among the slots 18 to create desired row widths, and then fills product in the rows between the dividers. At the same time, the pushers 14 are positioned at the rear portion 30 of the shelf to create room for stocking product. After the product is stocked, the shelf 13 is moved back to the sales position, so that the gravity release hardware 11 secures the shelf 13 in the sales position. The employee may also cause the security lock 16 to engage the release hardware 11 to further secure the shelf 13 in the sales position.

Although particular embodiments of the present invention have been shown and described, it will be understood that it is not intended to limit the present invention to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

We claim:

1. A product display system for a shelf, comprising:
a shelf comprising a front portion, a rear portion, and a bottom portion;
a pusher member moveable between the front portion and the rear portion;
a rotatable dispensing member located near the front portion;
a rotatable knob operably connected to the dispensing member such that rotation of the knob causes rotation of the dispensing member;
a trough portion located near the front portion; and
a hinged lid covering at least part of the trough portion;
wherein rotation of the dispensing member causes a product to be dispensed in the trough such that the product can be retrieved from the trough by moving the hinged lid to an open position; and
wherein access to products on the shelf is minimized when the hinged lid is in the open position.

2. The display system of claim 1, wherein the hinged lid further comprises a support and a product shield, wherein the support and the product shield further minimize access to merchandise on the shelf.

3. The display system of claim 1, further comprising dividers positioned in slots on the bottom portion.

4. The display system of claim 3, wherein the product dividers are positionable on the slots to create rows of varying widths.

5. The display system of claim 1, wherein the shelf is retractable by rotation of gravity release hardware.

6. The display system of claim 1, wherein when the hinged lid is in the open position a back surface of the hinged lid minimizes access to the products on the shelf.

7. The display system of claim 1, further comprising a piano hinge operably connected to the hinged lid, wherein the piano hinge facilitates movement of the hinged lid from a closed position to the open position.

8. The display system of claim 7, further comprising a panel member extending between the piano hinge and the hinged lid.

9. The display system of claim 8, wherein the panel member prevents access to product on the shelf behind the hinged lid when the piano hinge is in an open position.

10. The display system of claim 9, further comprising a tracking pin wherein the piano hinge is operably connected to a tracking pin, wherein the tracking pin moves within a tracking slot as the hinged lid is moved.

11. The display system of claim 10, wherein an angle imparted by the piano hinge moving to the open position is increased as the tracking pin moves upward within the tracking slot.

12. The display system of claim 1, wherein the rotation of the at least one knob causes a clicking noise that indicates product is being selected.

13. A method for retrieving product from a merchandise display system, comprising:
identifying a desired product on a shelf;
rotating a knob located approximately in the same vertical plane as the product, causing a dispensing disc operably connected to the knob and contacting the product to rotate as the knob is rotated, lifting the product to a height such that the product extends over the dispensing disc, thereby creating a void, rotation of the knob further causing a pusher member to move forward so that the void remaining from the product being lifted is occupied, whereby the product falls over the dispensing disc into a trough adjacent to the dispensing disc;
opening a lid covering the trough;
reaching into the trough to retrieve the product; and
releasing the lid.

14. The method of claim 13, wherein the step of opening of the lid limits access to additional product contacting the dispensing disc.

15. The method of claim 13, wherein the step of opening the lid limits access to additional product contacting the dispensing disc by a panel that extends from the lid moves in front of the additional product as the lid is opened.
